(19) United States
(12) Patent Application Publication
(10) Pub. No.: US 2017/0356560 A1
(43) Pub. Date: Dec. 14, 2017

(54) Tank Fill Adapter for Providing Air Gap Between Supply Pipe and Tank Inlet

(71) Applicant: Polywest Ltd., Winnipeg (CA)

(72) Inventors: Christopher R. Thompson, Sanford (CA); Thomas E. Northam, Winnipeg (CA)

(21) Appl. No.: 15/610,007

(22) Filed: May 31, 2017

Related U.S. Application Data
(60) Provisional application No. 62/347,879, filed on Jun. 9, 2016.

(51) Int. Cl. F16K 24/04; B65D 90/22; B65D 88/54

(52) U.S. Cl. CPC F16K 24/04; B65D 88/54; B65D 90/22

(57) ABSTRACT

A tank fill adapter device for a portable fluid tank provides a connection between an inlet collar of a tank and a supply pipe for filling the tank with a fluid that introduces an air gap into the connection. An annular mounting flange mounts against the inlet collar using a fastened connection. A pipe supporting portion protrudes upwardly from the annular mounting flange for supporting an open end of the supply pipe spaced above the inlet collar. An outer annular baffle protrudes downwardly from the annular mounting flange for being received into the tank through the inlet collar and an inner annular baffle is supported within the outer annular baffle to define a generally annular space between the outer and inner annular baffles which remains in open communication at a bottom end thereof with an interior of the tank.

This application claims the benefit under 35 U.S.C. 119(e) of U.S. provisional application Ser. No. 62/347,879, filed Jun. 9, 2016.

### FIELD OF THE INVENTION

The present invention relates to an adapter for coupling a fluid supply pipe to an inlet collar of a tank to be filled such that an air gap is effectively defined between the tank and the fluid supply pipe that prevents siphoning backflow from the tank to the fluid supply pipe.

### BACKGROUND

Operators of public water supply systems typically have safeguards in place to ensure that any connections made to their system cannot backflow and possibly contaminate the public water supply system. Many of these specific connections and safeguards are detailed in national plumbing code. At public water system “standpipes”, where typically truck mounted tanks are filled, the standard means of filling has traditionally been a pipe hanging vertically from overhead plumbing and this was lowered into the truck tank when it drove underneath it. In this procedure, as soon as the lowest point of the hanging pipe contacted the water in the truck tank, the possibility for contamination through contact or siphon, was created. Many public system operators are now eliminating the vertical hanging hose from their standpipes and installing water supply connections that require the user to hook a hose from that supply point to their truck. Operators are also requiring an anti-contamination device that is comprised of either: a permanent fixture mounted to the tank that ensures an air gap between the lowest point of outlet and the overflow level of the tank being filled, or an annually inspected back-flow prevention device. The preferred and most common solution has been the air gap method.

These fixtures have typically had the following problems:

i) In order to not have the tank's interior exposed to foreign material the lid needs to remain in place. Before the tank could be filled, the user would have to climb to the top of the tank and remove the lid with each tank fill and again climb the tank to re-install the lid after filling.

ii) Many people chose not to do this and instead would remove the lid permanently, remove a portion of the lid permanently, or cut a hole in the lid. This leaves the tank open to the top where it is most susceptible to taking in rainwater and debris. These opening also left the tank prone to sloshing water out of the tank during transport.

iii) On tanks that incorporated a hinged lid, opening the lid with a fixed pipe mounted above the lid was often impossible.

Various examples of prior art devices related generally to an air-gap device are described in the following: U.S. Pat. No. 4,467,830 by Hutchinson; U.S. Pat. No. 5,159,958 by Sand; U.S. Pat. No. 5,592,964 by Traylor; U.S. Pat. No. 5,813,702 by McGuire; U.S. Pat. No. 5,915,406 by Taylor; US 2006/0283502 by Hood; US 2012/0298213 by Forster et al; EP0905327 by Winkler; EP2947212 by McKenzie; and DE202008011255 by Dometic. The prior art devices are generally not suited for use between a supply pipe and a tank to be filled by the supply pipe.

The invention serves to provide the anti-contamination air gap between a tank collar and a supply pipe. It is a further benefit to the present invention to provided an air gap between a supply pipe and a tank while i) still allowing the user to have an intact lid installed on their tank, and ii) eliminating the need to operate the lid in any way during the filling process.

### SUMMARY OF THE INVENTION

According to one aspect of the invention there is provided a tank fill adapter device for connection between an inlet collar of a tank and a supply pipe for filling the tank with a fluid, the device comprising:

an annular mounting flange for mounting against the inlet collar using a fastened connection;

a pipe supporting portion protruding upwardly from the annular mounting flange for supporting an open end of the supply pipe spaced above the inlet collar;

an outer annular baffle protruding downwardly from the annular mounting flange for being received into the tank through the inlet collar;

an inner annular baffle supported within the outer annular baffle to define a generally annular space between the outer and inner annular baffles; and

a baffle supporting portion connected between the outer and inner annular baffles to support the inner annular baffle relative to the outer annular baffle such that the generally annular space between the outer and inner annular baffles remains in open communication at a bottom end thereof with an interior of the tank.

The baffle supporting portion may comprise a support flange extending radially between respective bottom ends of the outer and inner annular baffles in which the support flange includes at least one drain opening formed therein. A top end of the inner annular baffle may be near in elevation to the mounting flange.

The baffle supporting portion is preferably mounted between respective bottom ends of the outer and inner annular baffles spaced below the mounting flange.

The inner annular baffle may be tapered upwardly, while the outer annular baffle may be tapered downwardly. In this instance, the inner annular baffle is smaller in circumference at a top end than at a bottom end, and the outer annular baffle is smaller in circumference at a bottom end than at a top end.

The annular mounting flange may include i) an inner portion sized for overlapping an end face of the inlet collar of the tank for receiving fasteners therethrough to join the annular mounting flange to the inlet collar of the tank, and ii) an outer portion extending radially outward from the inner portion and locating at least one drain aperture therein such that the drain aperture is radially outward in relation to the end face of the inlet collar. In this instance, the pipe supporting portion may have a housing that is fully enclosed above the annular mounting flange locating said at least one drain aperture therein.

The pipe supporting portion preferably comprises a housing having an annular side wall extending upwardly from the annular mounting flange to a top end of the housing and a pipe aperture in the annular side wall at a location spaced below the top end of the housing which receives the supply pipe communicating radially therethrough. The housing may further include an access opening substantially fully spanning a top end of the housing and a lid which is operable relative to the access opening between a closed position in which the housing is fully enclosed above the annular mounting flange locating said at least one drain aperture therein and an open position in which the access open is substantially unobstructed by the lid. Furthermore, the annular side wall may include a cylindrical side wall portion and a flat wall portion which is generally planar and which locates the pipe aperture therein.

According to a second aspect of the present invention there is provided a tank fill adapter device for connection between an inlet collar of a tank and a supply pipe for filling the tank with a fluid, the device comprising:

a housing spanning over the inlet collar, the housing comprising:
an annular mounting flange for mounting against the inlet collar using a fastened connection;
an annular side wall extending upwardly from the annular mounting flange to a top end of the housing;
at least one drain opening in proximity to the annular mounting flange communicating fluid in the housing to an exterior of the housing and the tank; and
a pipe aperture in the annular side wall for receiving the supply pipe communicating radially therethrough;
the pipe aperture being located spaced above said at least one drain opening and spaced below the top end of the housing.

The housing may further include an access opening substantially fully spanning a top end of the housing and a lid which is operable relative to the access opening between a closed position in which the housing is fully enclosed above the annular mounting flange locating said at least one drain aperture therein and an open position in which the access open is substantially unobstructed by the lid.

The annular side wall may include a cylindrical side wall portion and a flat wall portion which is generally planar and which locates the pipe aperture therein.

According to a further aspect of the present invention there is provided a tank fill adapter device for connection between an inlet collar of a tank and a supply pipe for filling the tank with a fluid, the device comprising:

an annular mounting flange for mounting against the inlet collar; and

a pipe supporting housing protruding upwardly from the annular mounting flange for supporting an open end of the supply pipe spaced above the inlet collar;

wherein the annular mounting flange includes:
an inner portion sized for overlapping an end face of the inlet collar of the tank for receiving fasteners therethrough to join the annular mounting flange to the inlet collar of the tank; and
an outer portion extending radially outward from the inner portion and locating at least one drain aperture therein such that the drain aperture is radially outward in relation to the end face of the inlet collar;
whereby said at least one drain aperture is adapted to drain any fluid overflowing the inlet collar of the tank to an exterior of the housing.

Preferably the pipe supporting housing is fully enclosed above the annular mounting flange locating said at least one drain aperture therein.

As described herein, the tank fill adapter device provides an anti-contamination air gap between the water supply outlet at a public water fill station while still allowing for a closed lid on the tank being filled.

According to one preferred embodiment, the device utilizes a rotationally molded body which installs in the tank's original 16″ lid location. The upper portion of the body extends above the tank while the lower portion protrudes through the tank's lid opening. The top of the upper portion may have a hinged and vented lid which can be locked. The vertical sidewall of the upper portion has a flat surface for installation of a plumbing connection. Inside the upper portion is a pipe that directs water into the centre of the tanks lid opening. Along the outer circumference of the upper portion's bottom are holes which act as drains should the tank be overfilled and this horizontal surface is the effective overflow level of the tank. The inlet pipe's lowest point is high enough above the overflow level to ensure that an unobstructed air gap equal to twice the diameter of the fill pipe exists at all times. The lower portion of the body which protrudes into the tank consists of two offset walls that are joined at the bottom. This lower portion reduces the amount of water that may slosh into the upper portion of the body and escape through the drain holes. The bottom of this lower portion is made so that it will drain and not trap liquids in the lower portion.

### BRIEF DESCRIPTION OF THE DRAWINGS

One embodiment of the invention will now be described in conjunction with the accompanying drawings in which:

FIG. 1 is a side elevational view of the tank fill adapter device supported on the inlet collar of a truck mounted portable tank;

FIG. 2 is a perspective view of a bottom side of the tank fill adapter device;

FIG. 3 is a rear elevational view of the tank fill adapter device;

FIG. 4 is a perspective view of the tank fill adapter device installed on the inlet collar of the tank shown in cross section along the line 4-4 of FIG. 3;

FIG. 5 is a sectional view along the line 5-5 of FIG. 3; and

FIG. 6 is a sectional view along the line 6-6 of FIG. 3.

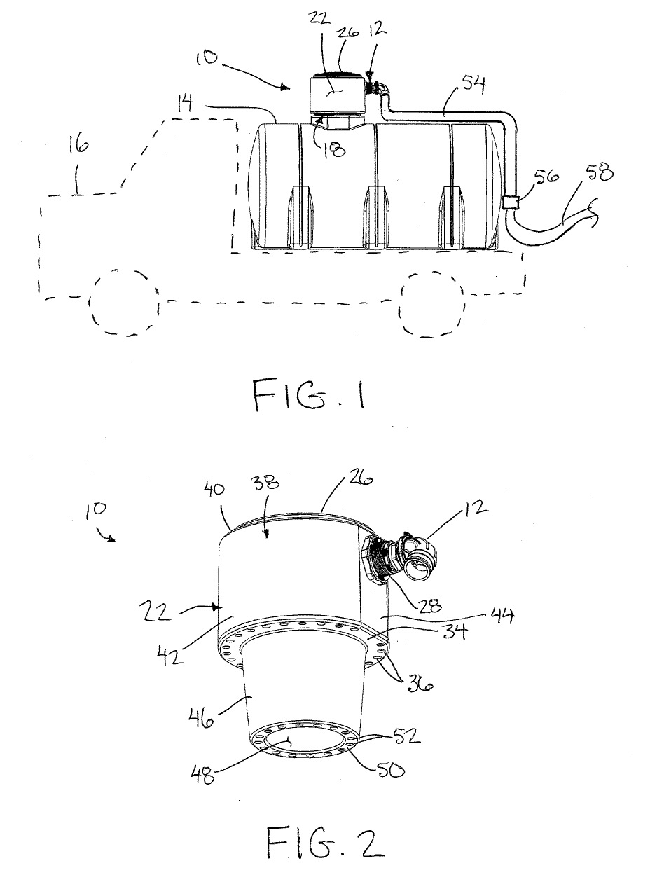

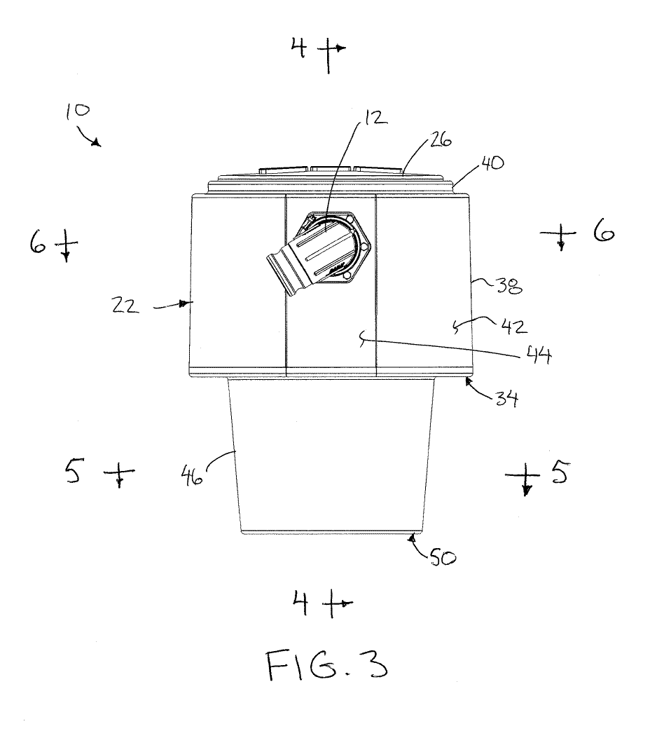

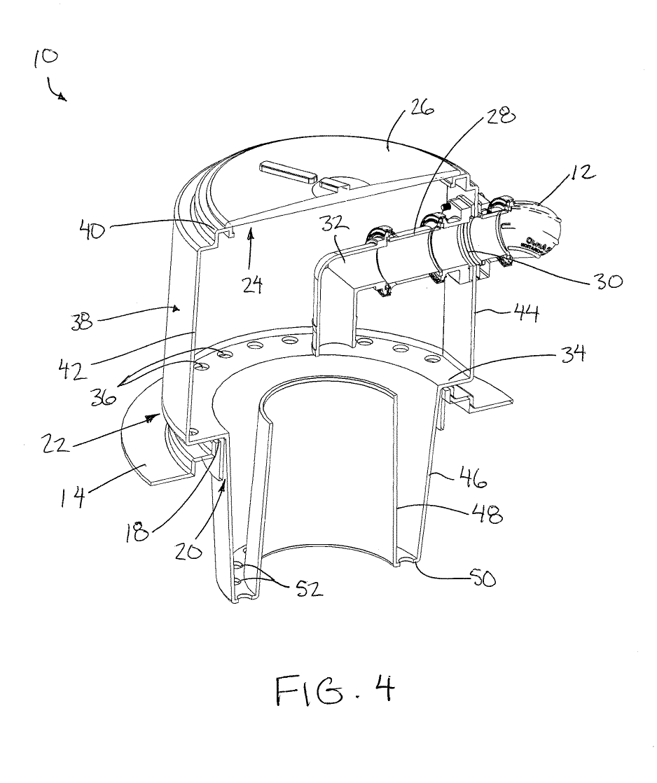

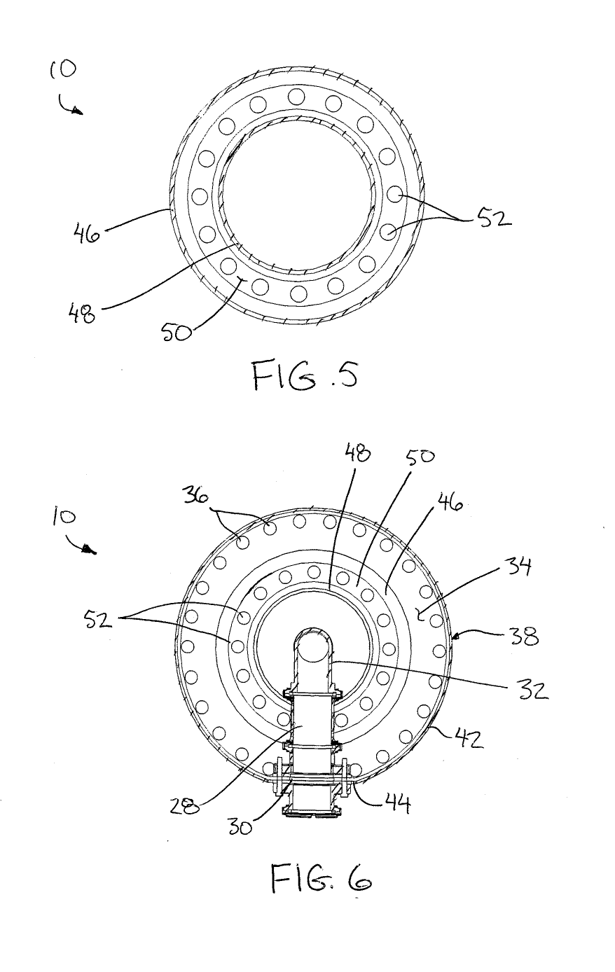

In the drawings like characters of reference indicate corresponding parts in the different figures.

### DETAILED DESCRIPTION

Referring to the accompanying figures there is illustrated a tank fill adapter device generally indicated by reference numeral 10. The device 10 provides an air gap between a tank and a fluid supply pipe 12 which connects to a supply of fluid, for example a municipal water supply.

In the illustrated embodiment, the tank 14 comprises a portable tank supported on a truck frame 16. The tank includes a generally cylindrical side wall extending horizontally between opposing end walls of the tank. An inlet collar 18 is integrally formed in the cylindrical side wall of the tank at the top end thereof which defines a fill opening 20 for receiving fluid therethrough to fill the tank. A top edge of the inlet collar 18 defines an annular end face surrounding the fill opening 20 while lying generally horizontally in a plane which is perpendicular to a central vertical axis of the fill opening.

The device 10 includes a unitary moulded body which defines a housing 22 which mounts on the inlet collar 18 to selectively enclose the fill opening 20 of the tank. The housing is open at the bottom end for communication with the interior of the tank. An access opening 24 is provided at the top end of the housing which is near in size to the cross-sectional area of the fill opening 20 of the inlet collar so as to be located concentrically relative to the fill opening 20 at a location spaced thereabove.

A lid 26 is arranged to be supported relative to the access opening 24 in the housing so as to be operable between a closed position fully spanning across the access opening 24 and an open position in which the access opening is substantially unobstructed by the lid. A hinge may support the lid on the housing for pivotal movement between the open and closed positions thereof. A lock may also be provided for selectively retaining the lid in the closed position when the lock is actuated to restrict access to the interior of the tank through the access opening by unauthorized persons.

The fluid supply pipe 12 includes a horizontal portion 28 which communicates through a pipe aperture 30 in the housing at an intermediate height which is spaced above the inlet collar of the tank by the housing and which is spaced below the access opening at the top end of the housing which is enclosed by the lid 26. An elbow section 32 of the supply pipe is connected at the inner end of the horizontal portion 28 so that the fluid passage within the supply pipe undergoes a bend of 90° to terminate at a free bottom end. The open bottom end of the rigid supply pipe is oriented in a horizontal plane to face downwardly, concentrically with the fill opening 20 of the inlet collar 18 therebelow. The housing 22 supports the open bottom end of the supply pipe at an elevation above the inlet collar 18 by a height which is greater than twice the diameter of the supply pipe to define an air gap between the rigid supply pipe and the inlet opening of the collar on the tank as described in further detail below.

The housing 22 generally includes an annular mounting flange 34 surrounding a central opening which aligns with the fill opening of the inlet collar. The annular flange 34 is flat and perpendicular to a central upright axis of the housing so as to extend generally radially from an inner edge defining the circumference of the central opening to an opposing outer edge. The annular flange 34 includes an inner portion adjacent to the inner edge having a radial width which corresponds approximately to the radial width of the end face of the inlet collar 18 of the tank such that the inner portion of the annular mounting flange lies in direct abutment against the annular end face of the inlet collar.

The annular mounting flange 34 also includes an outer portion which protrudes radially outward beyond the annular end face of the inlet collar 18 of the tank about the full circumference thereof such that the outer edge of the annular flange is greater in diameter than the end face of the inlet collar of the tank.

A plurality of exterior drain openings 36 are located in the outer portion of the annular mounting flange 34 at a location which is radially outward from the connection of the inner portion to the inlet collar of the tank such that the drain openings communicate from an interior of the housing 22 to an exterior of the housing at a location which is external to the tank therebelow.

The housing further includes an annular side wall 38 which extends generally vertically upward from the outer edge of the annular mounting flange 34 so as to be concentric with the central axis of the housing and the fill opening 20 of the inlet collar of the tank. The annular side wall extends upwardly from the annular mounting flange 34 to the top end of the housing. A top flange 40 extends inwardly from the side wall 38 about the full circumference of the housing to a respective inner free edge which defines the circumference of the access opening 24 at the top end of the housing. The top flange 40 forms an inverted channel providing the function of a rim about the access opening for mating connection with the lid 26 to enable the lid to be mated in a sealed relationship with the walls of the housing in the closed position while also enabling the lid to be selectively released from the housing in the open position thereof.

The annular side wall 38 of the housing includes a cylindrical wall portion 42 which is shaped to correspond to part of the shape of a cylinder which extends about most of the circumference of the annular side wall. For example, in the illustrated embodiment the cylindrical wall portion 42 extends through an arc of approximately 340° about the central axis of the housing. The annular side wall 38 of the housing further includes a flat wall portion 44 which extends about the remaining portion of the circumference of the housing. The flat wall portion 44 lies in a flat plane and locates the pipe aperture 30 therein. The pipe aperture 30 has a smaller dimension in the circumferential direction of the housing than the flat wall portion to enable a portion of the flat wall portion to fully surround the pipe aperture.

In one instance the horizontal portion 28 of the supply pipe can be externally threaded at the location of the pipe aperture to permit a pair of threaded collars to be threaded onto the horizontal portion 28 of the supply pipe for clamping a portion of the side wall of the housing between the two collars in a mounted position of the supply pipe relative to the side wall of the housing.

Alternatively, the supply pipe may include two pipe sections with respective pipe flanges at the inner ends thereof for mating against opposing inner and outer surfaces of the side wall of the housing. In this instance fasteners may be penetrated through a portion of the side wall about the periphery of the pipe aperture for clamping the two pipe flanges against the opposing surfaces of the side wall of the housing. Suitable gaskets may be used between the pipe flanges and the side wall portion of the housing clamped therebetween to seal the supply pipe relative to the side wall of the housing.

The device 10 also includes an outer baffle 46 which is annular in shape and which is joined to the inner edge of the mounting flange 34 about the full circumference of the housing to extend downward in the axial direction opposite from the annular side wall 38. The outer baffle 46 has an outer diameter which closely fits within the inner diameter of the inlet collar 18 of the tank at the top end of the outer baffle in proximity to the mounting flange 34. The outer baffle 46 is thus received into the tank through the inlet collar of the tank in a mounted position of the device relative to the tank. The height of the outer baffle extending below the mounting flange 34 in the axial direction is approximately equal to the height of the annular side wall 38 of the housing extending above the annular mounting flange 34. The outer baffle is generally frustoconical in shape so as to tapered downwardly and inwardly to a bottom end of the outer baffle which is smaller in diameter and circumference than the top end of the outer baffle.

The device 10 also includes an inner baffle 48 which is annular in shape and which is supported by a bottom support flange 50 to be concentrically received within the outer baffle 46. The bottom support flange 50 is an annular flange which supports the inner baffle relative to the outer baffle. The bottom support flange extends radially inwardly from the bottom end of the outer baffle to the bottom end of the inner baffle so as to lie in a flat plane oriented perpendicularly to the central upright axis of the housing. A plurality of interior drain openings 52 are provided at evenly spaced apart positions in the circumferential direction within the bottom support flange 50. The drain openings 52 communicate from the annular space defined between the inner and outer baffles to the bottom end of the device within the interior of the tank. Accordingly any fluid received in the annular space between the inner and outer baffles is openly communicated downwardly through the bottom end of the device into the interior of the tank.

The inner baffle 48 extends upwardly from the inner edge of the bottom support flange 50 about the full circumference thereof so as to be annular in shape. The inner baffle 48 is also frustoconical, however the inner baffle tapers upwardly and inwardly towards the top end thereof such that the diameter and circumference at the top end of the inner baffle is less than the diameter and circumference at the bottom end of the inner baffle. The height of the inner baffle is approximately equal to the height of the outer baffle such that the top edge of the inner baffle lies in a plane which is substantially coplanar with the annular mounting flange 34.

The opening defined at the top end of the inner baffle has a diameter which is shown to be approximately three times the diameter of the open end of the supply pipe while being concentrically aligned with the open end of the supply pipe. Accordingly any fluid discharged from the supply pipe tends to be received directly through the open top end of the inner baffle to be communicated directly to the open bottom end of the device into the interior of the tank. Any fluid which splashes into the annular space between the inner and outer baffles is also readily drained through the drain openings 52 back into the interior of the tank.

Should any overfilling of the tank occur, such that fluid from the tank overflows upwardly through the inner and outer baffles to the elevation of the annular mounting flange 34, the overflowing fluid will readily drain through the exterior drain openings 36 to the exterior of the housing and the exterior of the tank prior to reaching the open end of the supply pipe spaced thereabove. The exterior drain openings 36 are provided at evenly spaced apart positions in the circumferential direction. The collective size of the cross-sectional area of all the drain openings 36 is many times greater than the cross-sectional area of the open end of the supply pipe to enable fluid to drain away from the housing through the drain openings 36 faster than the interior of the housing can be filled by the supply pipe. This ensures a functional air gap is maintained between the open end of the rigid supply pipe and the fill opening 20 of the inlet collar 18 of the tank which is substantially at the elevation of the drain openings in the mounting flange 34.

Once the tank fill adapter device is installed in the inlet collar of a tank, the device 10 can remain in open communication with the interior of the tank with the lid of the device closed. When installed on a truck, an auxiliary pipe section 54 can be installed to communicate between the horizontal section 28 of the supply pipe which communicates through the pipe aperture 30 in the side wall of the tank and a suitable fitting 56 supported on the truck at an elevation which is accessible by an operator at ground level. When filling the tank, an operator simply connects a suitable hose 58 between the fitting 56 and the fluid supply, and then opens the valve on the fluid supply to discharge fluid through the auxiliary pipe section and into the housing of the device 10 through the supply pipe 12. Once complete, the valve of the fluid supply can be closed, and the hose 58 disconnected from the fitting 56. No further action is required by the operator as the lid of the device already remains closed.

In the closed position of the lid, the housing is fully enclosed above the annular mounting flange 34 locating the drain apertures therein to prevent debris from falling into the open top end of the inlet collar of the tank. Although in transport some fluid in the tank may splash upwardly through the open bottom of the baffles into the enclosed housing area above, the structure of the inner and outer baffles together with the interior drain openings 52 which communicate from the annular space between the baffles back into the interior of the tank ensures that the amount of fluid splashing upwardly tends to be reduced and mostly recaptured for draining back into the tank as opposed to being lost through the exterior drain openings 36 in the annular mounting flange 34.

Since various modifications can be made in my invention as herein above described, it is intended that all matter contained in the accompanying specification shall be interpreted as illustrative only and not in a limiting sense.

1. A tank fill adapter device for connection between an inlet collar of a tank and a supply pipe for filling the tank with a fluid, the device comprising:
an annular mounting flange for mounting against the inlet collar using a fastened connection;
a pipe supporting portion protruding upwardly from the annular mounting flange for supporting an open end of the supply pipe spaced above the inlet collar;
an outer annular baffle protruding downwardly from the annular mounting flange for being received into the tank through the inlet collar;
an inner annular baffle supported within the outer annular baffle to define a generally annular space between the outer and inner annular baffles; and
a baffle supporting portion connected between the outer and inner annular baffles to support the inner annular baffle relative to the outer annular baffle such that the generally annular space between the outer and inner annular baffles remains in open communication at a bottom end thereof with an interior of the tank.

2. The device according to claim 1 wherein the baffle supporting portion comprises a support flange extending radially between the outer and inner annular baffles, the support flange including at least one drain opening formed therein.

3. The device according to claim 1 wherein the baffle supporting portion is mounted between respective bottom ends of the outer and inner annular baffles spaced below the mounting flange.

4. The device according to claim 1 wherein a top end of the inner annular baffle is near in elevation to the mounting flange.

5. The device according to claim 1 wherein the inner annular baffle is smaller in circumference at a top end than at a bottom end.

6. The device according to claim 1 wherein the outer annular baffle is smaller in circumference at a bottom end than at a top end.

7. The device according to claim 1 wherein the annular mounting flange includes i) an inner portion sized for overlapping an end face of the inlet collar of the tank for receiving fasteners therethrough to join the annular mounting flange to the inlet collar of the tank, and ii) an outer portion extending radially outward from the inner portion and locating at least one drain aperture therein such that the drain aperture is radially outward in relation to the end face of the inlet collar.

8. The device according claim 7 wherein the pipe supporting portion comprises a housing that is fully enclosed above the annular mounting flange locating said at least one drain aperture therein.

9. The device according to claim 1 wherein the pipe supporting portion comprises a housing having an annular side wall extending upwardly from the annular mounting flange to a top end of the housing and a pipe aperture in the annular side wall at a location spaced below the top end of the housing which receives the supply pipe communicating radially therethrough.

10. The device according to claim 9 wherein the housing further includes an access opening substantially fully spanning a top end of the housing and a lid which is operable relative to the access opening between a closed position in which the housing is fully enclosed above the annular mounting flange locating said at least one drain aperture therein and an open position in which the access open is substantially unobstructed by the lid.

11. The device according to claim 9 wherein the annular side wall includes a cylindrical side wall portion and a flat wall portion which is generally planar and which locates the pipe aperture therein.

12. A tank fill adapter device for connection between an inlet collar of a tank and a supply pipe for filling the tank with a fluid, the device comprising:
a housing spanning over the inlet collar, the housing comprising:
an annular mounting flange for mounting against the inlet collar using a fastened connection;
an annular side wall extending upwardly from the annular mounting flange to a top end of the housing;
at least one drain opening in proximity to the annular mounting flange communicating fluid in the housing to an exterior of the housing and the tank; and
a pipe aperture in the annular side wall for receiving the supply pipe communicating radially therethrough;
the pipe aperture being located spaced above said at least one drain opening and spaced below the top end of the housing.

13. The device according to claim 12 wherein the housing further includes an access opening substantially fully spanning a top end of the housing and a lid which is operable relative to the access opening between a closed position in which the housing is fully enclosed above the annular mounting flange locating said at least one drain aperture therein and an open position in which the access open is substantially unobstructed by the lid.

14. The device according to claim 12 wherein the annular side wall includes a cylindrical side wall portion and a flat wall portion which is generally planar and which locates the pipe aperture therein.

15. A tank fill adapter device for connection between an inlet collar of a tank and a supply pipe for filling the tank with a fluid, the device comprising:
an annular mounting flange for mounting against the inlet collar; and
a pipe supporting housing protruding upwardly from the annular mounting flange for supporting an open end of the supply pipe spaced above the inlet collar;
wherein the annular mounting flange includes:
an inner portion sized for overlapping an end face of the inlet collar of the tank for receiving fasteners therethrough to join the annular mounting flange to the inlet collar of the tank; and
an outer portion extending radially outward from the inner portion and locating at least one drain aperture therein such that the drain aperture is radially outward in relation to the end face of the inlet collar;
whereby said at least one drain aperture is adapted to drain any fluid overflowing the inlet collar of the tank to an exterior of the housing.

16. The device according to claim 15 wherein the pipe supporting housing is fully enclosed above the annular mounting flange locating said at least one drain aperture therein.
